(19) United States
(12) Patent Application Publication
(10) Pub. No.: US 2016/0190730 A1
(43) Pub. Date: Jun. 30, 2016

(54) PROTECTION MEMBER FOR TRANSMISSION CABLE

(71) Applicant: Limitstyle Inc., Taipei City (TW)

(72) Inventor: Po-Sen Huang, Taipei City (TW)

(21) Appl. No.: 14/675,021

(22) Filed: Mar. 31, 2015

(30) Foreign Application Priority Data
Dec. 30, 2014 (TW) 103223316

(51) Int. Cl. H01R 13/56; H01R 13/502

(52) U.S. Cl. CPC H01R 13/562; H01R 13/502

(57) ABSTRACT

A protection member for a transmission cable includes a resilient coat and a fixing member. The resilient coat includes two resilient members connected to each other so as to receive the flexible wire of the transmission cable. A first connection portion is formed on the facing side of each of the resilient members. The two resilient members are connected to each other by the two respective first connection portions. The fixing member includes two hard members connected to each other so as to receive the resilient coat therein. A second connection portion is formed on the facing side of each of the hard members. The two hard members are connected to each other by the two respective second connection portions. The fixing member protects the flexible wire to be overly bent.

### BACKGROUND OF THE INVENTION

1. Fields of the Invention

The present invention relates to a protection member, and more particularly, to a protection member of a transmission cable for preventing the transmission cable from being bent and damaged.

2. Descriptions of the Prior Art

The conventional transmission cable generally comprises a connector and a cable which is connected to the connector. The connector is used to be connected with an appliance, and signals are transmitted via the cable. In practical use, the cable usually is curved or even bent according to the site of the appliance is located. In order to protect the connection area between the connector and the cable, a sleeve-like plastic coat is mounted to the connection area. However, the plastic coat can be damaged or broken by frequent pull and drag. In addition, the thickness of the plastic coat also affects the life of use of the plastic coat.

The present invention intends to provide a protection member to improve the shortcomings mentioned above.

### SUMMARY OF THE INVENTION

The present invention relates to a protection member for a transmission cable which has a flexible wire. The protection member comprises a resilient coat and a fixing member. The resilient coat has two resilient members which are connected to each other by two respective facing sides thereof. Each of the two resilient members has a first recess defined in the facing side thereof so as to receive the flexible wire. A first connection portion is formed on the facing side of each of the resilient members. The two resilient members is connected to each other by the two respective first connection portions.

The fixing member has two hard members which are connected to each other by two respective facing sides thereof. Each of the two hard members has a second recess defined in the facing side thereof so as to receive the resilient coat. A second connection is formed on the facing side of each of the hard members. The two hard members are connected to each other by the two respective second connection portions.

Preferably, the fixing member is shorter than the resilient coat.

Preferably, each of the resilient members has a recessed portion formed on two sides thereof. The two sides of each of the hard members are located in the two recessed portions.

Preferably, the first recess of each resilient member has two sections with different sizes.

Preferably, the first connection portion of each resilient member has multiple tabs and multiple slots.

Preferably, the first connection portion comprises multiple tabs on one of the resilient members, and multiple slots in the other resilient member. The tabs are inserted in the slots.

Preferably, the first connection portion comprises multiple rods and multiple holes formed on each of the resilient members. The rods are inserted in the holes.

Preferably, the second connection portion comprises multiple rods and multiple holes formed on each of the two hard members.

Preferably, the second connection portion comprises multiple rods formed on one of the two hard members, and multiple holes defined in the other of the two hard members. The rods are inserted into the holes.

The primary object of the present invention is to provide a protection member for a transmission cable wherein the flexible wire can be bent while be protected by the fixing member.

Another object of the present invention is to provide a protection member for a transmission cable wherein the resilient members and the hard members are easily connected assembled at desired position of the transmission cable.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the protection member of the present invention is combined with the transmission cable;

FIG. 2 is an exploded view to show the protection member of the present invention is combined with the transmission cable;

FIG. 3 is a cross sectional view of the protection member of the present invention connected to the transmission cable;

FIG. 4 is a cross sectional view of the first connection portion of the first embodiment of the protection member of the present invention;

FIG. 5 is a cross sectional view of the second connection portion of the first embodiment of the protection member of the present invention;

FIG. 6 is a cross sectional view of the first connection portion of the second embodiment of the protection member of the present invention;

FIG. 7 is a cross sectional view of the second connection portion of the second embodiment of the protection member of the present invention;

FIG. 8 is an exploded view of the third embodiment of the protection member of the present invention, and

FIG. 9 is an exploded view of the fourth embodiment of the protection member of the present invention.

### DETAILED DESCRIPTION OF THE PREFERRED EMBODIMENT

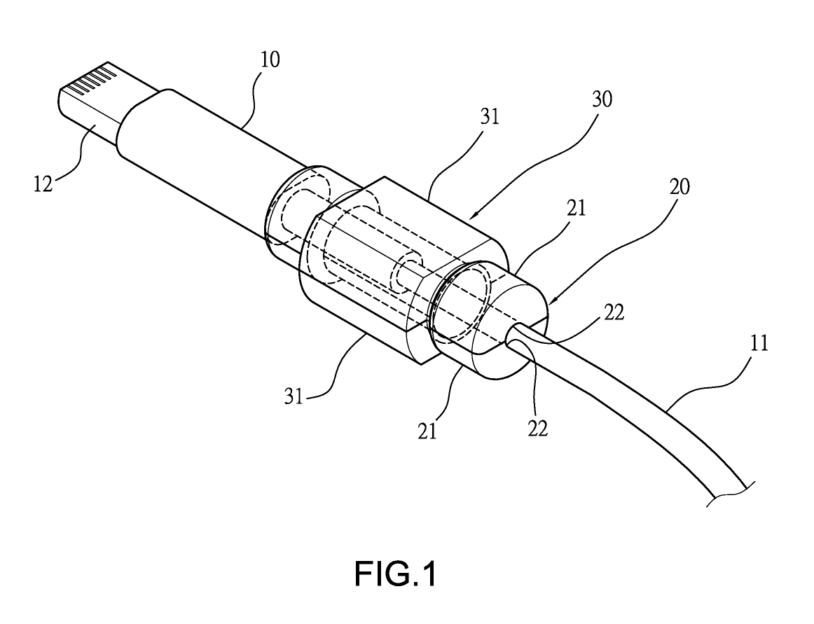

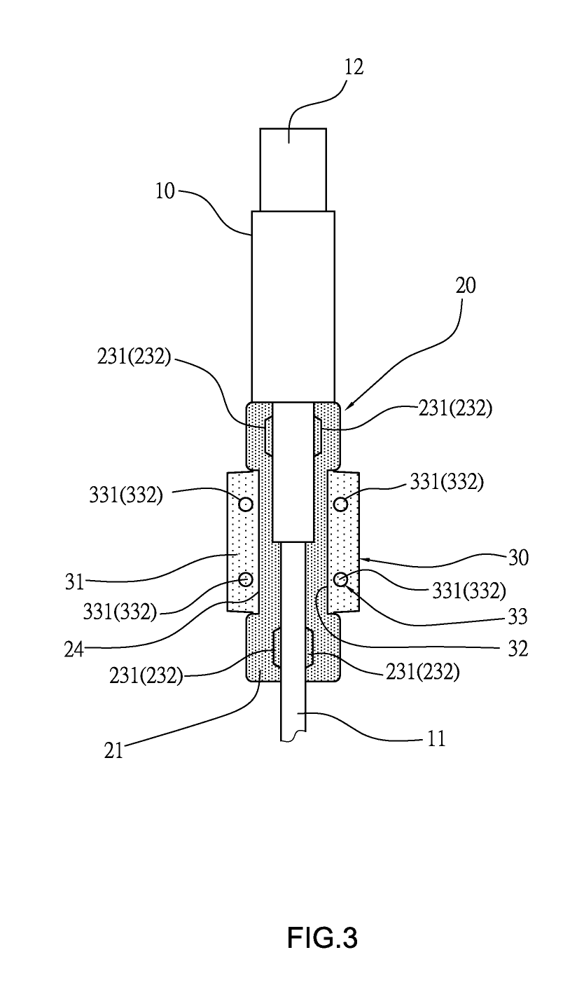

Referring to FIGS. 1 to 5, the protection member of the present invention is combined with the transmission cable 10 which has a flexible wire 11. The protection member of the present invention comprises a resilient coat 20 and a fixing member 30. The resilient coat 20 comprises two resilient members 21 which are connected to each other by two respective facing sides thereof. Each of the two resilient members 21 has a first recess 22 defined in the facing side thereof. The first recess 22 of each resilient member 21 has two sections with different sizes so as to allow the transmission cable 10 to be fitted therein. A first connection portion 23 is formed on the facing side of each of the resilient members 21. The two resilient members 21 are connected to each other by the two respective first connection portions 23. The resilient members 21 can be made by natural or artificial rubber.

The fixing member 30 has two hard members 31 which are connected to each other by two respective facing sides thereof. Each of the two hard members 31 has a second recess 32 defined in the facing side thereof so as to receive the resilient coat 20. A second connection 33 is formed on the facing side of each of the hard members 31. The two hard members 31 are then connected to each other by the two respective second connection portions 33. The fixing member 30 is shorter than the resilient coat 20. The hard members 31 are made by plastic, metal or wood.

Each of the resilient members 21 has a recessed portion 24 formed on two sides thereof. The two sides of each of the hard members 31 are fitted in the two recessed portions 24. Therefore, the resilient coat 20 is accommodated in the fixing member 30.

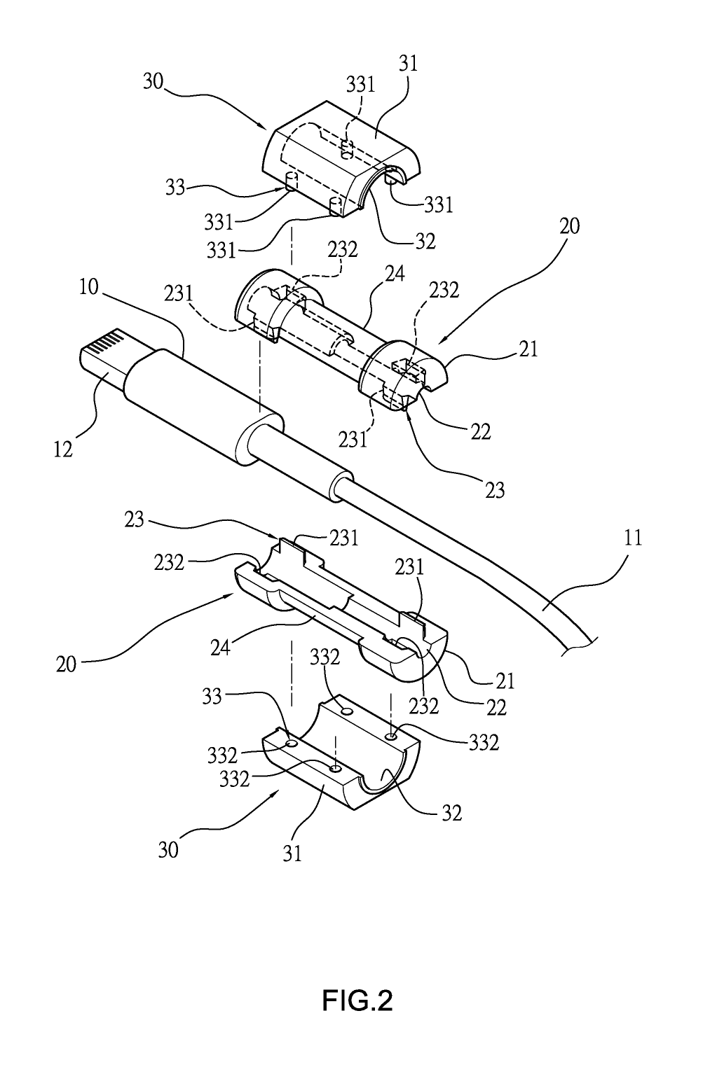

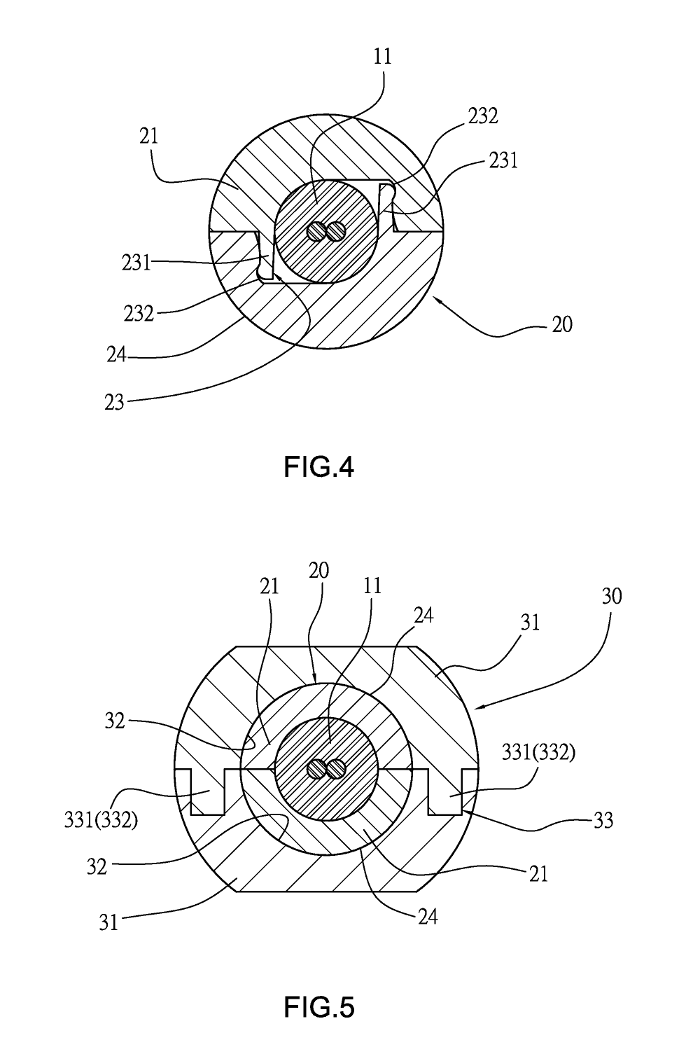

As shown in FIGS. 2 to 5, the first connection portion 23 of each resilient member 21 has multiple tabs 231 and multiple slots 232 as shown in FIG. 4. The second connection portion 33 comprises multiple rods 331 formed on one of the two hard members 31, and multiple holes 332 defined in the other of the two hard members 31. The rods 331 are inserted into the holes 332 as shown in FIG. 5.

The resilient member 20 is coated to the bending area such as the connection portion between the flexible wire 11 and the connector 12 of the transmission cable 10. The resilient member 20 is mounted to the position where the thickness of the coat on the flexible wire changes.

The resilient member 20 is combined with the flexible wire 11 and the fixing member 30 reinforces the strength of the position of the transmission cable 10 so that the flexible wire 11 can be reasonably bent or curved, while the fixing member 30 prevents that position from being broken or damaged. The two sides of each of the hard members 31 are fitted in the recessed portions 24 of the resilient members 21, and the fixing member 30 is shorter than the resilient coat 20, so that the two end sections of the resilient coat 20 protruded from the two ends of the fixing member 30 are effectively protect the flexible wire 11. Besides, by the engagement between the two sides of each of the hard members 31 fitted in the recessed portions 24 of the resilient members 21, the fixing member 30 is secured to the resilient coat 20. The first recess 22 of each resilient member 21 has two sections with different sizes so that the transmission cable 10 is fitted therein.

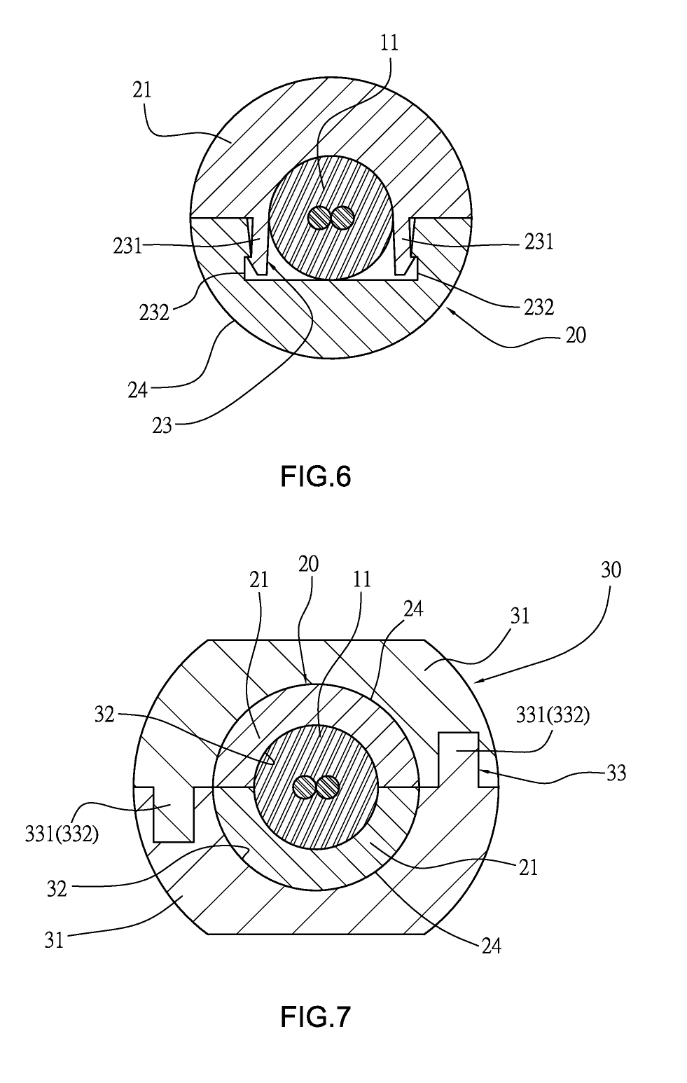

As shown in FIG. 6, the first connection portion 23 may comprise multiple tabs 231 on one of the resilient members 21, and multiple slots 232 are defined in the other resilient member 21. The tabs 231 are inserted in the slots 232. Alternatively, as shown in FIG. 7, the second connection portion 33 may comprise multiple rods 331 and multiple holes 332 formed on each of the two hard members 31.

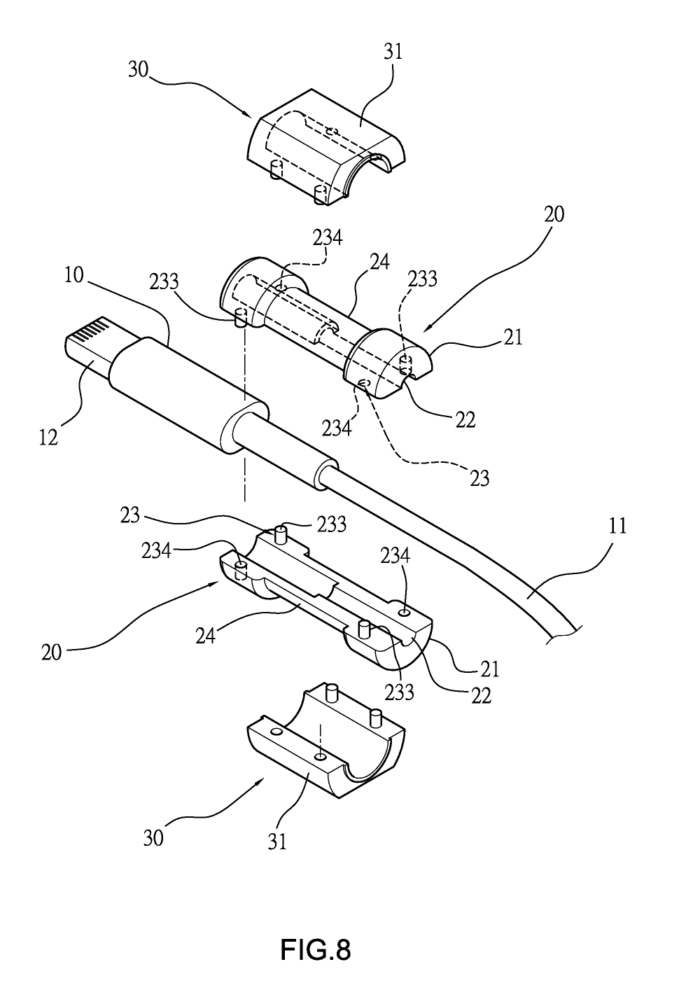

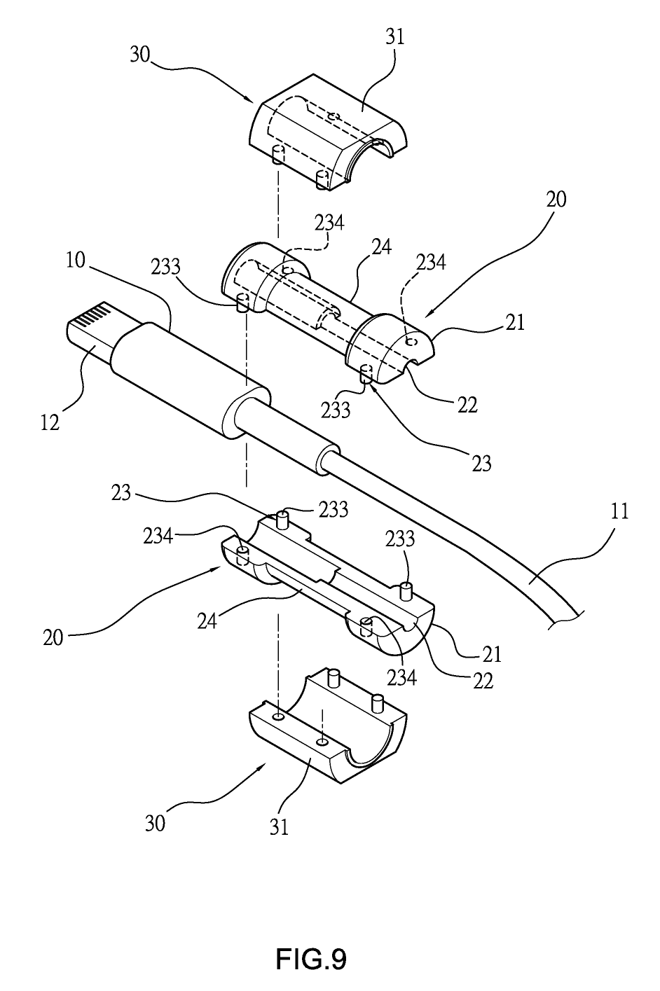

As shown in FIGS. 8 and 9, the first connection portion 23 may comprise multiple rods 233 and multiple holes 234 formed on each of the resilient members 21. The rods 233 are inserted in the holes 234. As shown in FIG. 8, the rods 233 are located on two sides of each of the resilient members 21, and the holes 234 are located on two sides of each of the resilient members 21. As shown in FIG. 9, the rods 233 are located on one side of each of the resilient members 21, and the holes 234 are located on the other side of each of the resilient members 21.

While we have shown and described the embodiment in accordance with the present invention, it should be clear to those skilled in the art that further embodiments may be made without departing from the scope of the present invention.

What is claimed is:

1. A protection member for a transmission cable which has a flexible wire, comprising:
a resilient coat having two resilient members which are connected to each other by two respective facing sides thereof, each of the two resilient members having a first recess defined in the facing side thereof so as to be adapted to receive the flexible wire, a first connection portion formed on the facing side of each of the resilient members, the two resilient members being connected to each other by the two respective first connection portions, and
a fixing member having two hard members which are connected to each other by two respective facing sides thereof, each of the two hard members having a second recess defined in the facing side thereof so as to receive the resilient coat, a second connection formed on the facing side of each of the hard members, the two hard members being connected to each other by the two respective second connection portions.

2. The protection member as claimed in claim 1, wherein the fixing member is shorter than the resilient coat.

3. The protection member as claimed in claim 2, wherein the fixing member is shorter than the resilient coat, each of the resilient members has a recessed portion formed on two sides thereof, two sides of each of the hard members are fitted in the two recessed portions.

4. The protection member as claimed in claim 1, wherein the first recess of each resilient member has two sections with different sizes.

5. The protection member as claimed in claim 1, wherein the fixing member is shorter than the resilient coat, each of the resilient members has a recessed portion formed on two sides thereof, two sides of each of the hard members are fitted in the two recessed portions, the first recess of each resilient member has two sections with different sizes.

6. The protection member as claimed in claim 5, wherein the first connection portion of each resilient member has multiple tabs and multiple slots.

7. The protection member as claimed in claim 5, wherein the first connection portion comprises multiple tabs on one of the resilient members, and multiple slots in the other resilient member, the tabs are inserted in the slots.

8. The protection member as claimed in claim 5, wherein the first connection portion comprises multiple rods and multiple holes formed on each of the resilient members, the rods are inserted in the holes.

9. The protection member as claimed in claim 5, wherein the second connection portion comprises multiple rods and multiple holes formed on each of the two hard members.

10. The protection member as claimed in claim 5, wherein the second connection portion comprises multiple rods formed on one of the two hard members, and multiple holes defined in the other of the two hard members, the rods are inserted into the holes.
